(19) United States
(12) Patent Application Publication
(10) Pub. No.: US 2025/0345804 A1
(43) Pub. Date: Nov. 13, 2025

(54) SHELL LINER FOR A STIRRED GRINDING MILL

(71) Applicant: METSO FINLAND OY, Espoo (FI)

(72) Inventors: Rodrigo Rizzoli, Sorocaba (BR); Michael Christopher Rice, Elizabethtown, PA (US)

(73) Assignee: METSO FINLAND OY, Espoo (FI)

(21) Appl. No.: 18/659,448

(22) Filed: May 9, 2024

(51) Int. Cl. B02C 17/22; B02C 17/16

(52) U.S. Cl. CPC B02C 17/22; B02C 17/163

(57) ABSTRACT

A shell liner for a stirred grinding mill is configured to be releasably fitted to the inside of a shell of the mill within a grinding chamber thereof. At least a part of a surface of the shell liner that is configured to be exposed within the grinding chamber constitutes a wear surface. The shell liner includes at least one polymer-ceramics panel having an elastic material layer and wear resistant inserts retained by the elastic material layer. Exposed surfaces of the wear resistant inserts form part of the wear surface of the shell liner.

### FIELD OF THE INVENTION

The invention relates to improvements in stirred mills for grinding e.g. mineral ore particles.

### BACKGROUND OF THE INVENTION

A stirred mill, also known as attritor mill, is a type of mill used for grinding and mixing materials such as chemicals, ores, pyrotechnics, paints, and ceramics. It consists of a vertical vessel with a central shaft and impellers that stir the media in a specific pattern.

Stirred bead grinding mills are typically used in mineral processing to grind mineral ore particles into smaller sized particles to facilitate further downstream processing, such as separation of the valuable mineral particles from unwanted gangue. For example, mineral ore particles in the range of about 30 μm to 4000 μm in diameter may be ground down to particles of 5 to 100 μm in diameter. This process is commonly known as fine and ultra-fine grinding.

A stirred bead grinding mill typically has a stationary mill body or shell and an internal drive shaft. The shell and the drive shaft can be arranged vertically in the mill; this kind of mill is also known as a tower mill. The drive shaft has a plurality of stirring elements, such as rotor disks or rotors, so that rotation of the drive shaft also rotates the stirring elements, which in turn stirs a suitable grinding media, and the mineral ore particles, in the form of a feed slurry, passes through this stirred bed of media. The resulting stirring action causes the mineral ore particles to be ground into smaller sized particles. In other words, in contrast to tumbling mills such as ball mills where motion is imparted to the charge via the rotation of the mill shell, in tower and stirred mills motion is imparted to the charge by the movement of an internal stirrer while the shell remains stationary.

Exemplary stirred bead grinding mills are known from WO 2017/017315 A1 and WO 2018/138405 A1.

In stirred media mills, the shear forces are significant, and in practice, wear is inevitable even in well designed and built equipment. The rotor disks and the shell tend to suffer from high wear, especially when the grinding mill is operated at high speeds through the action of the harder grinding media acting against the rotor disks. Accelerated wear of the components of the grinding mill makes their operational life very short, thus requiring more frequent replacement than desired. Replacement of grinding mill components results in downtime, reducing the efficiency of the grinding mill, as well as increasing maintenance costs.

To protect the inner peripheral surface of the shell of a grinding mill from wear, shell liners are commonly used that are mounted to the inner peripheral surface and replaced once worn away to a significant extent.

In spite of these improvements, there is still need for reducing wear of the components of the grinding mills, reducing the time and work required for replacement of components, reducing the downtime, and/or reducing maintenance costs.

### GENERAL DESCRIPTION OF THE INVENTION

It is the object underlying the present invention to provide a shell liner for a stirred grinding mill that provides for a longer wear life than conventional liners.

This object is achieved by means of a shell liner and a stirred grinding mill, respectively.

The shell liner of this invention is a shell liner for a stirred grinding mill, wherein the shell liner is configured to be releasably fitted to the inside of a shell of the mill within a grinding chamber thereof. At least a part of a surface of the shell liner that is configured to be exposed within the grinding chamber constitutes a wear surface. The shell liner comprises at least one polymer-ceramics panel comprising an elastic material layer and wear resistant inserts retained by the elastic material layer, wherein exposed surfaces of the wear resistant inserts form part of the wear surface of the shell liner.

The material of the elastic material layer can be a polymer material, particularly an elastomer material, such as rubber, isoprene, polybutadiene, butadiene, nitrile, ethylene, propylene, chloroprene or silicone rubber, or a mixture thereof, including filling or auxiliary materials and impurities at up to 30% by volume.

The inserts can be metallic or ceramic inserts or made from a cermet composite. If metallic, they can be of an iron based metal, including metallic carbides or oxides in a proportion of up to 50% by volume. If ceramic, they can consist of carbides or oxides of metallic elements, such as aluminum, titanium, tantalum, wolfram, chromium or zirconium or of mixtures thereof. If cermet, they can include carbides or oxides of metallic elements, such as aluminum, titanium, tantalum, wolfram, chromium or zirconium or a mixture thereof and of a metallic binder, said binder being of a plain metal or a metal alloy and having cobalt, nickel or iron as the main component of the binder.

The wear resistant inserts can be attached to the elastic material layer by vulcanizing, e.g. by vulcanizing ceramic inserts into a layer of polymer based material, or by means of glue or adhesive. Alternatively or in addition, the wear resistant inserts can be retained within the elastic material layer mechanically by means of a press fit and/or a form fit.

In general terms, the combination between wear-resistant, e.g. ceramics elements and an elastic, e.g. rubber layer is advantageous insofar as ceramics are mainly adapted to compensate for sliding or abrasive wear, whereas rubber is mainly adapted for compensating impact wear. The shell liner of the present invention thereby provides for a longer wear life than conventional steel liners. The reduction of wear will also reduce the downtimes which are needed for replacing worn parts.

Ceramic-rubber composites have been known in the art, e.g. from U.S. Pat. No. 3,607,606 which discloses a composite of rubber, natural or synthetic, and alumina-based ceramic, useful as a wear-resistant lining for ball mills, conveyors, chutes and the like. The composite comprises a layer of rubber having embedded in and bonded to the surface thereof closely spaced shaped bodies of alumina-base ceramic. WO-A1-2006/132582 also relates to wear-resistant lining elements intended for a surface subjected to wear and which has an outwardly directed surface, over which material in the form of pieces or particles, such as crushed ore and crushed rock material, is intended to move. Chutes and truck platforms are mentioned as examples. The wear-resistant lining element comprises elastomeric material mainly adapted to absorb impact energy and wear-resistant members mainly adapted to resist wear. These are preferably made from ceramics material. According to WO 2008/087247 A1, similar composite materials are used in wear parts of a vertical shaft impactor, e.g. distributor plates, and WO 2017/174147 A1 describes a crusher, e.g. gyratory or cone crusher, with a protective liner that comprises an elastic material layer and wear resistant inserts retained by the elastic material layer, wherein outwardly directed surfaces of the wear resistant inserts form part of the wear surface of the shell liner.

To be suitably adapted in shape to the shell to which it is designed to be mounted, the shell liner of the invention may be curved into the shape of a segment of a hollow cylinder. Should the shape of the shell differ from a cylindrical shape, the shell liner would be adapted in shape accordingly, however.

While the shell liner could in principle consist of only the aforementioned polymer-ceramics panel or a plurality of such panels, the shell liner comprises in one embodiment also a reinforcement plate supporting the at least one polymer-ceramics panel. The reinforcement plate could be brought into the final shape—e.g. half cylindrical shape as explained above-before or after the polymer-ceramics panel(s) is/are attached to the reinforcement plate. The reinforcement made is suitably made of steel, e.g. S235 grade structural steel or ASTM A36 structural steel. The reinforcement plate may also comprise, or be made from, a plastic, such as fibre glass, PU or other plastic materials and composites.

In any shell liner of this invention, a plurality of the polymer-ceramics panels can be disposed in at least one row and/or at least one column. In one preferred embodiment, a number of polymer-ceramics panels are arranged in an array of several rows and several columns, such as 6 rows×4 columns, or 5 rows×5 columns. Shell liners of the invention can also comprise only one row or only one column of polymer-ceramics panels.

In embodiments, a shell liner of this invention comprises at least two polymer-ceramics panels spaced apart from one another in a height direction of the panel.

Any shell liner of this invention may further comprise at least one mounting hole for fixing stator elements, such as stator rings, or segments thereof. The stator elements or segments, e.g. stator rings or stator ring segments may be made from e.g. polyurethane (PU), steel, or suitable metal alloys.

In a combination of the two aforementioned aspects, at least one mounting hole is disposed in the spacing between the two panels.

To accommodate for uneven wear along the length or height of the shell, a thickness of a first polymer-ceramics panel of the shell liner may be set to be larger than a thickness of a second polymer-ceramics panel of the shell liner, the variation in thickness resulting from the panels having elastic material layers with different thicknesses and/or wear-resistant inserts with different dimensions in a thickness direction of the panels.

Alternatively or in addition to that, at least one of the polymer-ceramics panel of the liner may have a bulge or other thickened area where the thickness of the elastic material layer and/or the dimension of the wear resistant inserts in the thickness direction of the panel is larger than in other areas of the panel. The bulge or other thickened area may suitably be positioned where the panel is configured to face a rotor disk configured to rotate in the grinding chamber of the mill, and/or where excessive wear occurs for other reasons. The bulge or other thickened area could e.g. extend along a width of the liner and thereby along an inner circumference of the shell in the shell-mounted state of the liner so as to provide improved wear properties about the entire circumference of the shell.

The invention also provides a stirred grinding mill comprising a grinding chamber and a stirring assembly arranged in the grinding chamber for rotating therein, wherein the crusher further comprises at least one shell liner according to the invention that is releasably fitted to the inside of a shell of the mill within the grinding chamber thereof.

The shell liner may be releasably fitted to the inside of the shell of the mill by fastening the elastic material layer of the at least one polymer-ceramics panel of the liner to the inside of the shell. In an alternative in which the shell liner further comprises the reinforcement plate, the shell liner would be releasably fitted to the inside of the shell of the mill by fastening the reinforcement plate of the liner to the inside of the shell. Due to the releasable fitting of the shell liner, the shell liner can be replaced quite easily and quickly.

A stirred grinding mill of this invention may comprise several shell liners disposed adjacent to each other along the circumference and/or along the length of the shell of the mill.

If several shell liners are provided, a thickness of at least one polymer-ceramics panel of a shell liner disposed further towards the bottom or inlet end of the shell is larger than a thickness of at least one polymer-ceramics panel of a shell liner disposed further towards the top or outlet end of the shell, the variation in thickness resulting from the panels having elastic material layers with different thicknesses and/or wear-resistant inserts with different dimensions in a thickness direction of the panels.

The invention is readily applicable to various types of stirred bead grinding mills having a stationary grinding shell and a rotating stirring assembly.

In accordance with known types of stirred grinding mills, the stirring assembly of the stirred grinding mill may comprise a drive shaft with a number of rotor disks disposed along the length of the drive shaft, in which case the mill could e.g. be a HIGmill™. The invention is applicable to any kind of stirred mill, however, including horizontal stirred mills.

One exemplary vertical mill to which the present invention is applicable comprises a mill body, shaft with rotor disks, shell mounted stator rings, gearbox, and drive. The grinding chamber is filled up to 70% with inert ceramic grinding media beads. Rotors stir the charge and grinding takes place between beads by attrition. The number of rotors (grinding stages) depends on the application, i.e. is as high as the individual application requires. Feed slurry is pumped into the bottom mill.

As the flow transfers upwards, the ore slurry passes through the rotating disks and the free space between the static counter disks lining the wall. The number of sets of rotating and static disks is chosen depending on the application. Due to the vertical arrangement of the mill, classification is conducted simultaneously throughout the grinding process with larger particles remaining longer at the peripheral, while smaller particles move upwards. The process is typically a single pass with no external classification necessary.

Gravity keeps the media compact during operation, ensuring high intensity inter-bead contact and efficient, even energy transfer throughout the volume. The disk configuration and the whole chamber geometry have been optimized for efficient energy transfer to the bead mass, internal circulation and classification. With the grinding media evenly distributed, the ore particles remain in constant contact, significantly increasing grinding efficiency. The final product discharges from the top of the mill into the open atmosphere.

The casing of the mill may be flanged vertically so that it can be split down the centre into two halves that can be moved apart on a railing system. After exposing the internals, changing of disks and liner segments can be done individually by a team of two skilled mechanical trade personnel. Wear of the disks is even around the circumference. The wear is faster in the bottom part of the mill and typically the lowest disks may have to be replaced before the total set is changed. For total set change, a spare shaft ready for installation is an option. Wear components can be lined with polyurethane, metal hard facing or natural rubber depending on application.

Typical applications for a stirred mill of this invention is the regrinding of concentrates (e.g. magnetic, flotation), iron ore tertiary grinding, precious metal ores, and fine grinding for hydrometallurgical processes. Both ceramic and steel beads can be used. Ceramic media is typically used for sulphide concentrate regrinding to prevent iron contamination on the sulphide mineral surface, which would otherwise result in poorer flotation recovery and grade. The mill can use a wide range of grinding media diameter which depends on the application: 0.5-1.5 mm in ultra fine, 1-3 mm in fine grinding and 3-6 mm in coarse grinding, where the grinding size is defined as follows:
Coarse range, F80 100-300 μm, P80 50-100 μm
Fine range, F80 50-100 μm, P80 20-60 μm
Ultra fine range F80<70 μm, P80<20 μm

In an existing HIGmill™, shell liners according to this invention achieved over 4,000 hours or approximately doubled the wear life compared to a standard PU liner.

In an alternative, the stirring assembly of a mill of this invention may comprise an agitator screw arranged concentrically with and inside the grinding chamber for rotating therein.

The cylindrical grinding chamber could be arranged essentially vertically, or essentially horizontally.

Embodiments of the invention are readily applicable to many different types of particulate materials and are not limited to particular mineral ore types, but can include iron, quartz, copper, nickel, zinc, lead, gold, silver and platinum. Other particulate materials that can be processed using embodiments of the invention include concrete, cement, recyclable materials (such as glass, ceramics, electronics and metals), food, paint pigment, abrasives and pharmaceutical substances. In these other applications, embodiments of the invention are used to reduce the size of the particulate material using a grinding process.

### BRIEF DESCRIPTION OF THE DRAWINGS

In the following the invention will be described in greater detail by means of exemplary embodiments with reference to the attached drawings, in which

FIG. 1 is a perspective view of an exemplary grinding mill suitable for comprising grinding elements according to an embodiment of the invention;

FIG. 2 is a side view of the grinding mill of FIG. 1;

FIG. 3 is a front view of the grinding mill of FIG. 1;

FIG. 4 is a schematic longitudinal cross-section of an exemplary mill body used in the grinding mill of FIG. 1;

FIG. 5 is a perspective view of an exemplary castellated rotor disk;

FIG. 6 is a schematic explosive view of a grinding mill comprising shell liners;

FIG. 7a is a perspective view of an embodiment of a shell liner of this invention, in a curved state;

FIG. 7b is a front view of the shell liner of FIG. 7a;

FIG. 7c is a cross sectional view along the line C-C in FIG. 7b;

FIG. 7d is a cross sectional view along the line D-D in FIG. 7b;

FIG. 7e show a detail singled out in FIG. 7d;

FIG. 7f show a detail singled out in FIG. 7b;

FIG. 8 shows a shell liner of this invention with segments of stator rings mounted thereto;

FIG. 9a shows a shell liner of the invention in a flat state;

FIG. 9b is a cross sectional view along the line B-B in FIG. 9a;

FIG. 9c is a side view of the shell liner of FIG. 9a;

FIG. 10a is a front view of one polymer-ceramic panel of the shell liner of FIGS. 9a-c

FIG. 10b is a cross sectional view along the line B-B in FIG. 10a;

FIG. 11 is a view corresponding to FIG. 4 and indicating areas of pronounced wear at the inner periphery of the shell; and

FIG. 12 is a side view of a shell liner according to a modified embodiment of this invention wherein some of the polymer-ceramic panels are provided with bulges in areas of pronounced wear.

### EXEMPLARY EMBODIMENTS OF THE INVENTION

In the following, embodiments of shell liners for stirred grinding mills are illustrated, here exemplified by a vertical stirred bead grinding mill. Identical reference numerals designate identical or corresponding components throughout the individual Figures.

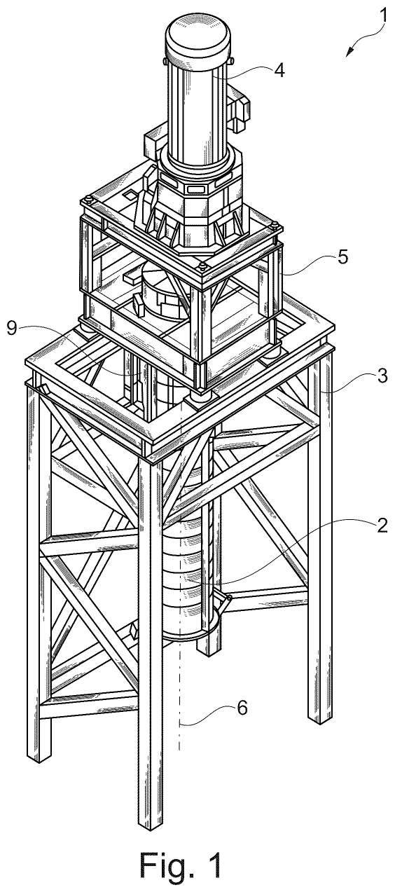

FIGS. 1 to 3 illustrate an exemplary stirred bead grinding mill 1 for grinding a slurry having particulate material. A mill 1 of this kind comprises a mill body 2 and a drive mechanism 4 for rotating a drive shaft 11 of the mill body 2 about a longitudinal axis 6 and thereby provide a stirring action to the slurry in the mill body 2. The mill body 2 and the drive mechanism 4 are mounted on a frame structure, such as on a base frame 3 and a drive frame 5, respectively. The mill body 2 comprises a mounting assembly 9 for fitting the mill body to the base frame 3 and operatively aligning the mill body to the drive mechanism 4.

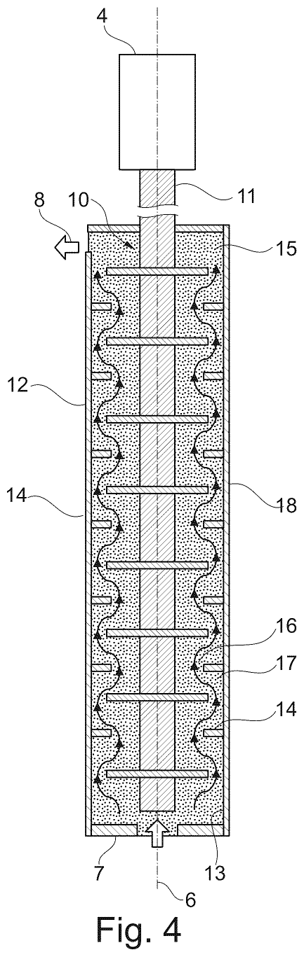

The grinding mill may be any kind of stirred mill, such as for example be a fine grinding mill of the type known as a high intensity grinding mill. In a stirred mill, the rotating action of the drive shaft within the mill body results in intense grinding of slurry particles by grinding media in a manner described in more detail further below (with reference to FIG. 4).

Grinding mills may have a relatively high power consumption in order to achieve fine grinding, e.g. in the range from 5 kWhr/t to 100 kWhr/t (kilowatt hours per tonne). The power intensity, kW/m3, of the grinding mills may also be relatively high, e.g. up to 100-300 kW/m3, or more.

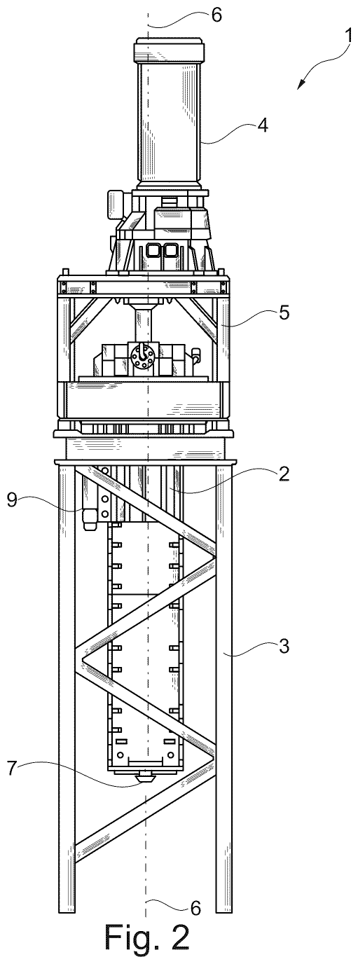

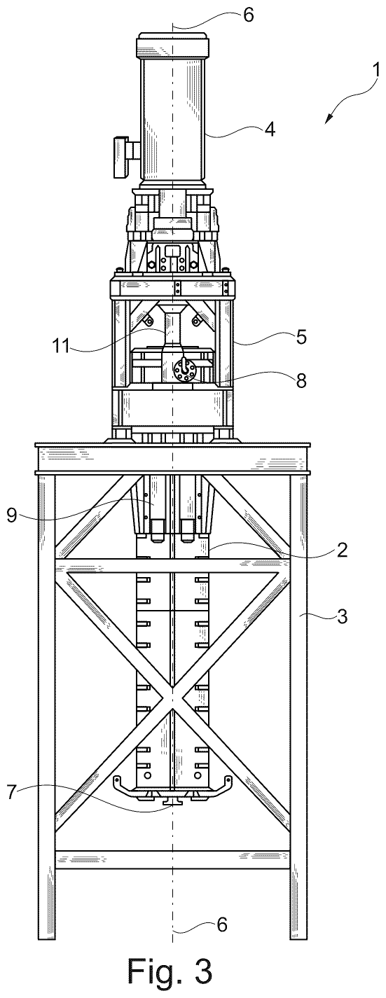

To operate a grinding mill of this kind, a charge of feed slurry comprising e.g. mineral ore particles is fed into the mill body 2 through a bottom inlet 7 that is shown as a centred inlet in this example (see FIG. 2). The mill body 2 may be partially filled (e.g. about ⅔ filled) with grinding media, such as small beads. Grinding media may also be added into the mill body 2 initially through an outlet 8 (see FIG. 3), or via a separate entry into the top of the mill, before the feed slurry (e.g. the particulate material and a slurrying liquid) is added and the grinding mill 1 is put into operation.

In operation, the drive shaft 11 inside the mill body 2 is rotated by the drive mechanism 4 about the axis 6 to rotate or stir the feed slurry and grinding media together, thereby providing relative motion of the slurry of grinding media and particulate material at a desired speed within a grinding chamber 15 inside the mill body 2 and causing the feed slurry particles to be crushed or ground against and between the grinding media, whereby comminution takes place by attrition between the grinding media. The ground product is then discharged through the top outlet 8.

The grinding media may typically comprise ceramic or steel beads that range from e.g. 0.5 mm to 50 mm in diameter. The size of the grinding media may vary depending on requirements.

FIG. 4 is a schematic sectional view of a stirred bead grinding mill that operates according to the same principles as the mill shown in FIGS. 1-3. In the illustrated exemplary embodiment, the mill body 2 has a stationary grinding shell, or drum, 18 that is arranged vertically in the grinding mill and has the aforementioned bottom inlet 7 and top outlet 8. In other embodiments, the inlet 7 and outlet 8 can be placed at locations of the shell other than the bottom and top, respectively.

The generally cylindrical drum or shell 18 defines the internal cavity or grinding chamber 15. The term “cylindrical” as used herein shall be understood to refer generally to any cylinder-like structure with circular or round cross-section, and although in the illustrated exemplary embodiments the mill body 2 has generally cylindrical shape, it will be appreciated that the mill body or the shell 18 can take other cross-sectional shapes in other embodiments, such as rectangular, square, oval or oval-like, or any other regular or irregular polygonal shape, such as the hexagonal, defining the grinding chamber 15.

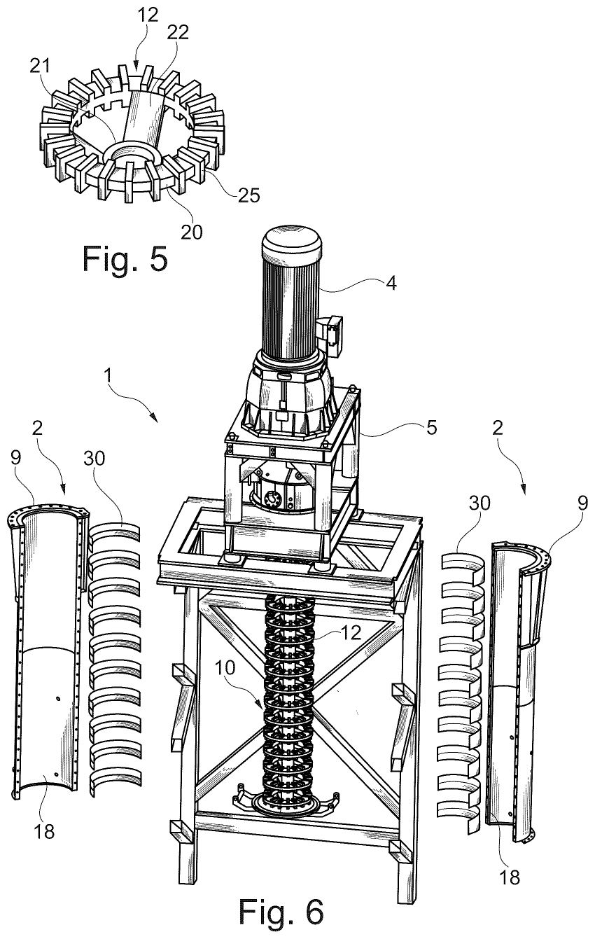

A rotating stirring assembly 10 is positioned within the shell 18. The stirring assembly 10 comprises the aforementioned drive shaft 11 to which a number of grinding rotor disks 12 are mounted that are described in more detail below (with reference to FIG. 5). The drive shaft 11 may be coaxial with the mill body 2 or the shell 18 thereof, respectively (e.g. as illustrated in the exemplary embodiments). The drives shaft 111 may be parallel to a longitudinal axis 6 of the mill body 2, as illustrated in the exemplary embodiments, or the drive shaft may be inclined or at an angle to the axis of the mill body.

In the illustrated embodiment, the rotor disks 12 are disposed in regular intervals along the longitudinal axis of the drive shaft 11 and coaxially with the axis of the drive shaft 11.

At an inner circumferential surface 13 of the stationary grinding shell 18, a plurality of stator elements such as rings 14 are disposed so as to protrude into the grinding chamber 15, with each stator ring 14 being positioned between two rotor disks 12 as seen in the height direction of the shell 18, i.e. along the axis 6. The stator rings 14 thereby subdivide the grinding chamber 15 into compartments 17 interconnected through passages between the stator rings 14 and the drive shaft 11, the passages being defined by central openings 16 within the stator rings. Depending on the application, there can be any number of sets of (rotating) rotor disks 12 and (stationary) stator rings 14. For example, there may be up to several dozens of sets, but typically 5-20.

The stator rings or stator ring segments may be made from e.g. polymers such as polyurethane (PU), rubber, or mixtures of polymers, or from steel or suitable metal alloys. Stator elements other than rings could be used, such as baffles or ribs, grooves and/or lifters depending on the application.

In operation, the drive mechanism 4 rotates the drive shaft 11 of the stirring assembly 10, rotating the rotor disks 12 that in turn impart a rotational motion to the slurry of the grinding media and the particulate material at a desired speed within the grinding chamber 15 of the mill body 2. The rotational motion causes the feed slurry particles to be ground against and between the harder grinding media, thus releasing valuable mineral particles and reducing them in size for further downstream processing after being discharged through the outlet 8. The slurry flows upward through the grinding chamber 15, passing the individual compartments 17, from the bottom to the top of the shell 18.

Each compartment 17 can be regarded as a classification stage where coarser particles move towards the internal wall of the shell 18 while finer particles move faster upwards through the passages 16. Due to the vertical arrangement of the mill 1, classification is conducted simultaneously throughout the grinding process with larger particles remaining longer at the peripheral, while smaller particles move upwards.

In other words, in the exemplary vertical stirred bead mill the feed slurry is fed from below, with particles—e.g. ore particles-being progressively ground smaller by the moving grinding media beads before exiting from the top of the grinding mill. The grinding media beads are significantly larger (e.g. tens of times larger) than the ore particles, which is necessary for grinding, and also keeps the grinding media beads inside the grinding mill due to their ability to settle faster than the upward flow rate of the feed slurry. The mill may be, however, sized such that the grinding media beads are partially fluidised by the upward flowing feed slurry. The electric power draw to drive the shaft is sensitive to the feed flow rate, i.e. at higher flow rates the grinding media beads are lifted slightly and exert less resistance on the rotor disks. In a horizontal stirred bead mill, a centrifugal separator may be provided at the end of the mill to keep the beads and coarser particles in the mill.

An example of a rotor disk 12 is illustrated in FIG. 5. In the exemplary embodiment, the rotor disk 12 comprises a flat disc body 20 that is connected via arms 22 (typically known as spokes) to a mounting ring 21 for mounting the rotor disk 12 to the drive shaft 11 of the stirring assembly 10. This exemplary embodiment of a rotor disk 12 is also provided with a castellation 25 in the form of block-like elements that are integrally formed with the disc body 20 and arranged so that opposed sides and one end of the blocks project outwardly from the planar surfaces and outer edge of the disk body 20. Each block 25 may thus extend both substantially orthogonally relative to the opposed planar surfaces via its opposed sides and radially outwardly from the outer edge via its end. The castellation 25 can take any number of forms in order to create the zone around each rotor disk 12. Examples of other forms or shapes of the protective elements are disclosed in WO 2017/017315 A1.

In stirred media mills, the shear forces are significant, and in practice, wear is inevitable even in well designed and built equipment. Accelerated wear of the components of the grinding mill makes their operational life very short, thus requiring more frequent replacement than desired. Replacement of grinding mill components results in downtime, reducing the efficiency of the grinding mill, as well as increasing maintenance costs.

To protect the inner peripheral surface of the shell 18 of the mill 1 from wear, shell liners are commonly used that are mounted to the inner peripheral surface and replaced once worn away to a significant extent. FIG. 6 shows an exemplary installation of such shell liners, schematically illustrated here at 30, within a shell 18 of a grinding mill body 2. In the illustrated example, the shell 18 axially (e.g. vertically on a vertical mill and horizontally on a horizontal mill) split into two halves 18a, 18b; it could also be divided into three or more segments that can be moved apart. The halves or other segments of the shell 18 may be flanged axially (vertically) so that they can be separated. For example, the two halves of the mil body 2 may be hinged together, so that upon taking out flange bolts or like, the shell halves can be swung apart.

After opening up the shell 18, shell liners 30 can be installed or mounted to the inside of the shell halves 18a, 18b or other segments. Also the rotor disks 12 can now be readily changed, if desired.

In the illustrated example, ten shell liners 30 each having the shape of a half cylinder are disposed within each half 18a, 18b of the shell 18. The shell liners 30 may be arranged to tightly or loosely fit against the inner surface of the shell 18 and prevent the shell 18 from wearing. The shell liners 30 may be connected to the shell segments 18a, 18b by appropriate connecting means. The shell liners 30 may also be drop-in units. Any shell liners 30 may either be replaced one by one, or all of them may be replaced in the entire shell at one time.

Worn shell liners 30 can be easily replaced by a reverse procedure: the mill body 2 is separated into the halves, the worn shell liners 30 are replaced, and the mill body is reassembled.

In conventional stirred mills, the shell liners 30 are made from e.g. polyurethane. The polyurethane wears away, in particular in areas towards the bottom of the shell 18 where abrasive forces are most pronounced, wherein wear is most prominent in areas of the liners that directly face the rotor disks. If the PU liner is not replaced before exposing the mill shell, this results in damage to the mill shell.

The shell liners according to the invention have an improved wear life. In accordance with the invention, a shell liner includes an elastic material layer which has wear-resistant parts embedded at least in a surface area thereof which forms a wear surface. Each wear resistant part has an exposed surface forming part of the wear surface of the shell liner. The remainder of each wear resistant part is immersed in the elastic material layer.

The elastic material layer can be a polymer layer, and the wear-resistant parts can be ceramic inserts. One possible implementation would be a layer made from a composite polymer-ceramics material. Therefore, the wear surface of the shell liner will also be referred to as a “polymer-ceramics layer” in the following.

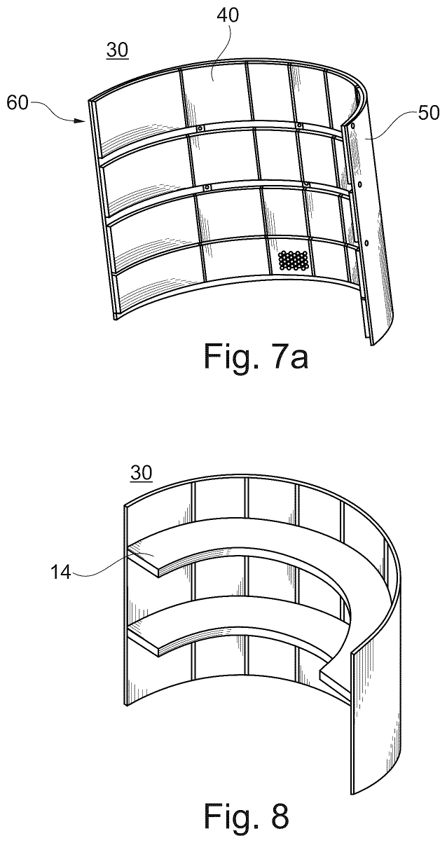

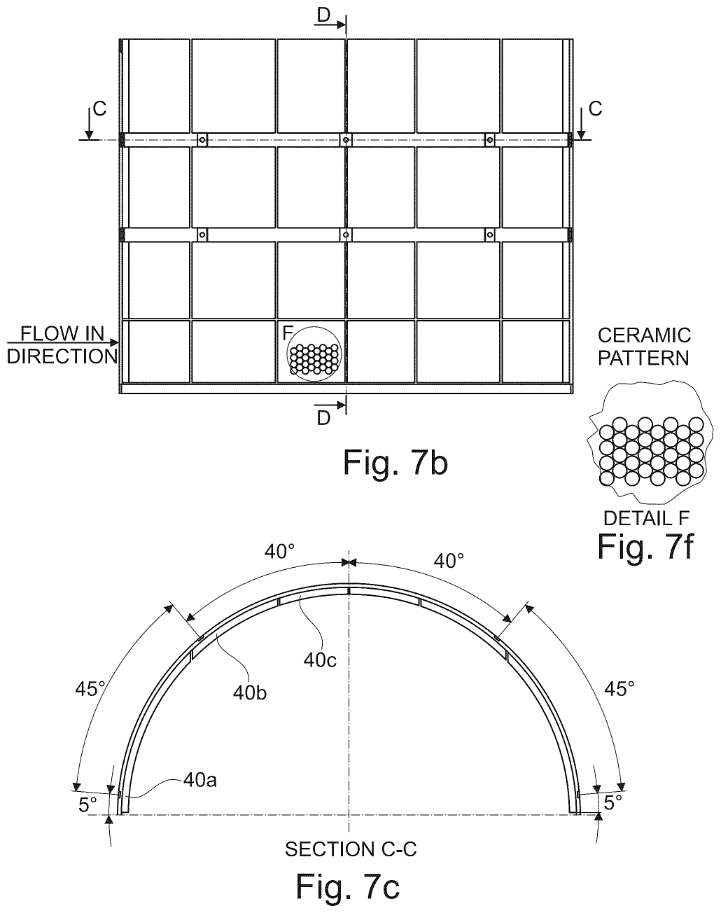

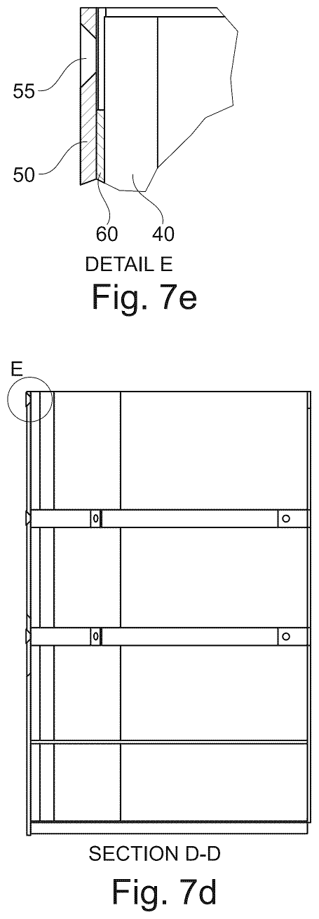

FIG. 7a is a perspective view of one embodiment of a shell liner 30 according to this invention. The shell liner 30 of this embodiment of the invention is made up from essentially three components, namely a number of polymer-ceramics panels 40, a reinforcement plate 50 made of e.g. steel, and a vulcanized rubber layer 60 supporting the polymer-ceramics panels 40 to the reinforcement plate 50. The reinforcement plate 50 carrying the polymer-ceramics panels 40 has been bent into a curved shape complementary to the shape of one half 18a, 18b of the shell 18.

In the embodiment of FIG. 7a, the shell liner 30 comprises a total of 24 polymer-ceramic panels 40 arranged in four rows and six columns.

In between the first and second rows of panels 40 from the top and in between the second and third rows, the panels 40 are spaced to provide room to attach the aforementioned stator rings 14 or segments thereof, respectively, as shown schematically in FIG. 8. Attachment means 55 in the form of bolt holes are provided for that purpose. The exemplary shell liner 30 therefore provides room for two stator rings 14 in the axial direction. A shell liner of this invention could also have only two rows of polymer-ceramic panels spaced to provide room for the attachment of one stator ring 14 or segment thereof, respectively, or it could have more than two spacings between rows of polymer-ceramic panels along the height of the shell liner 30. A shell liner 30 of the invention could also comprise only one row of polymer-ceramic panels 40, in which case the stator rings 14 or segments could e.g. be mounted to the shell 18 in between two shell liners 30 as seen in the axial direction of the shell 18.

FIGS. 7b-7f are further views of the shell liner 30 of FIG. 7a: FIG. 7b is a front view, FIG. 7c a sectional view along the line C-C in FIG. 7b, FIG. 7d a sectional view along the line D-D in FIG. 7b, and FIGS. 7e and 7f show details singled out in FIGS. 7d and 7b, respectively.

It is apparent from these drawings that polymer-ceramic panels of different sizes are combined in the shell liner 30 of this embodiment: The polymer-ceramic panels are arranged in a total of six columns and four rows in this embodiment. The dimension of the panels along the width, i.e. along the circumferential direction of the rounded or curved shell liner 30 is largest for the panels 40a in the outermost rows, and smallest for the panels 40c in the two rows at the center of the shell liner 30.

Also, the individual polymer-ceramic panels 40a-c have curved profiles, adapted to the curved shape of the reinforcement plate 50 that supports the panels 40.

As to suitable dimensions of the individual components of the shell liner 30, the polymer-ceramic panels 40 could each have a thickness of e.g. 30 mm, the reinforcement plate 32 could have a thickness of e.g. 10 mm, and the intermediate rubber layer 60 could have a thickness of e.g. 5 mm. Suitable thickness ranges are 20-100 mm for the panels 40, 5-15 mm for the reinforcement plate 32, and 2-20 mm for the intermediate rubber layer 60.

The shell liner 30 of FIGS. 7a-7f has the shape of a half hollow cylinder, so that respective liners placed at the same height within each of the shell halves 18a, 18b (in the manner generally indicated in FIG. 6) would combine into a hollow cylinder to protect the inside of the shell 18 about the entire circumference thereof. Similarly three shell liners of 120 degrees, or four shell liners of 90 degrees may be placed within the shell 18 to combine into a hollow cylinder. In embodiments, the shell liner 30 may also be a stand-alone element adapted for a loose fit mounting within a grinding shell 18.

In embodiments, a shell liner has a height (corresponding to an axial length in the mounted state of the liner) that is approximately equal to or a multiple of the distance between the axially spaced rotor disks 12 of the central stirring shaft 11.

In embodiments, the shell liner 30 is dimensioned to be stacked up with one or more further shell liners 30 in the axial direction within the cylindrical grinding shell 18 to cover the inside of the shell 18 about essentially its whole axial length.

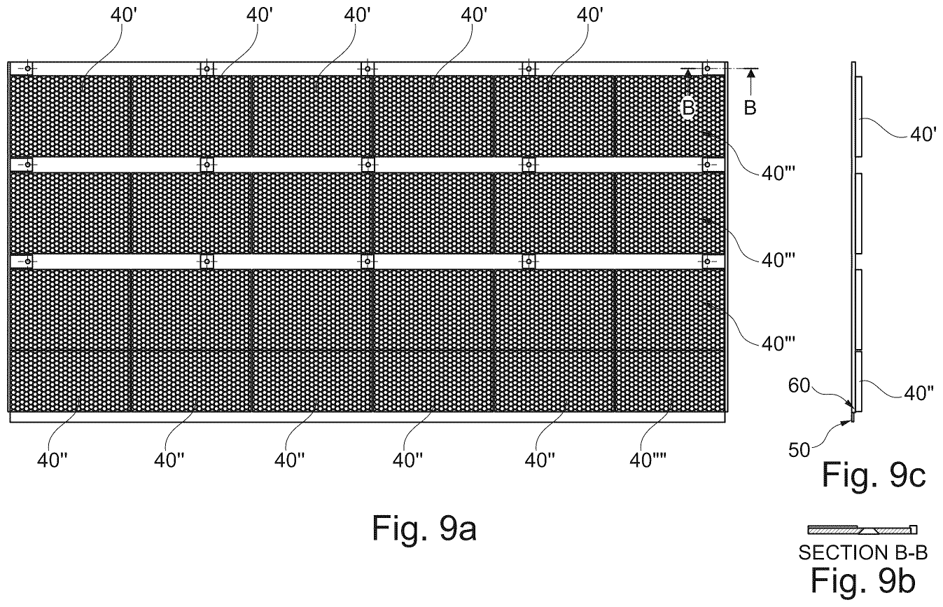

FIGS. 9a-9c show a shell liner 30 of this invention, identical with or similar to the shell liner 30 described above with reference to FIGS. 7a-7f, in a flat state. FIGS. 9a-9c are a front view, a cross-sectional detail along a line B-B in FIG. 9a, and a side view, respectively, of the shell liner 30. Polymer-ceramic panels 40′ of identical size are used across the liner 30 except for the last row at the bottom and the last column on the right hand side in the drawing where panels 40″, 40′″, and 40″″ (in the bottom right location) are used instead.

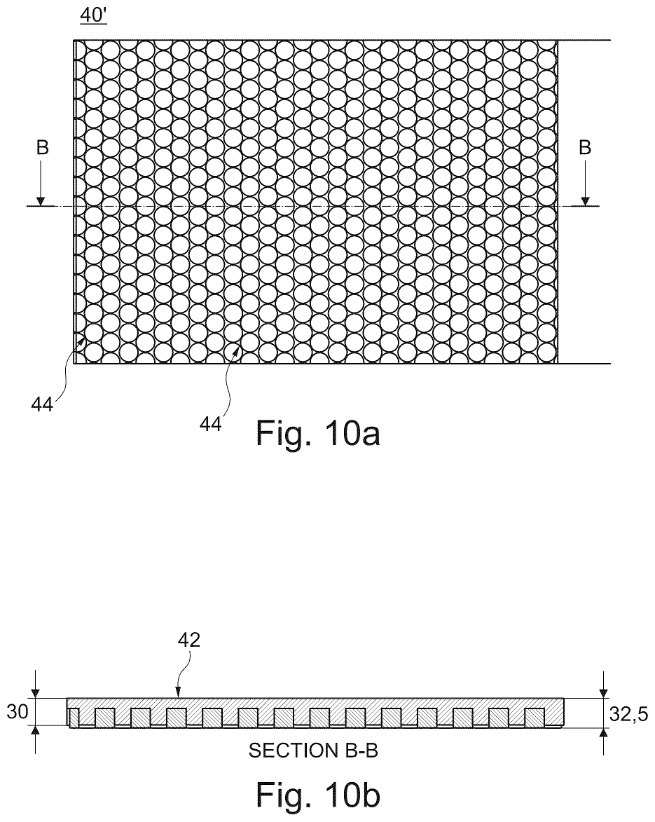

FIG. 10a is a front view of an individual polymer-ceramic panel 40′, specifically of the size and shape used in the embodiment of FIGS. 9a-c (except for the bottom row and outermost column of panels where panels 40″, 40″, and 40″″ are used instead as explained further above). FIG. 10b is a sectional view along the line B-B in FIG. 10a.

In any embodiment of this invention, the material of the elastic material layer 42 can be a polymer material, particularly an elastomer material, such as rubber, isoprene, polybutadiene, butadiene, nitrile, ethylene, propylene, chloroprene or silicone rubber, or a mixture thereof, including filling or auxiliary materials and impurities max. 30% by volume.

The inserts 44 can be metallic or ceramic inserts or made from a cermet composite. If metallic, they can be of an iron based metal, including metallic carbides or oxides in a proportion of 10-50% by volume. If ceramic, they can consist of carbides or oxides of metallic elements, such as aluminum, titanium, tantalum, wolfram, chromium or zirconium or of mixtures thereof. If cermet, they can include carbides or oxides of metallic elements, such as aluminum, titanium, tantalum, wolfram, chromium or zirconium or a mixture thereof and of a metallic binder, said binder being of a plain metal or a metal alloy and having cobalt, nickel or iron as the main component of the binder.

As shown in the various Figures and specifically in FIGS. 10a and 10b, a polymer-ceramic panel 40 of this invention consists of a polymer layer 42 in which ceramic inserts 44 are embedded, thereby forming a wear surface. In the mounted state of the liner 30 comprising this panel 40, the wear surface will face towards the inside of the grinding chamber 15 so as to be exposed to the material passing through the chamber 15.

Each wear resistant insert 44 has an exposed surface forming part of the wear surface of the polymer-ceramic panel 40 and thereby of the shell liner 30. The remainder of each insert 44 is immersed in the polymer material 42 of the panel 40. As shown in FIG. 10b, the inserts 44 slightly protrude from the polymer material 42, e.g. by about 2.5 mm.

On its side opposite the ceramic inserts 44, the polymer layer 42 of the panel 40 would be supported by the reinforcement plate 50 to which it would be adhered by the vulcanized rubber layer 60 as shown in e.g. FIGS. 7a-7b.

The combination between wear-resistant, e.g. ceramics elements 44 and an elastic, e.g. polymer layer 42 is advantageous insofar as ceramics are mainly adapted to compensate for sliding or abrasive wear, whereas polymer is mainly adapted for compensating impact wear. The shell liner 30 of the present invention thereby provides for a longer wear life than conventional, e.g. PU liners. The reduction of wear will also reduce the downtimes which are needed for replacing worn parts.

In general terms, the mutual proportions of the elastic material 42 and the wear-resistant inserts 44 depend on the wear conditions and the location and manner of attachment of the shell liner within the mill. According to one embodiment, the wear-resistant inserts 44 can be arranged and distributed about the elastic material layer 42 so that the exposed surface of at least one area of the shell liner 30 mainly consists of the wear-resistant members 44.

In the illustrated embodiments, the ceramic inserts 44 are distributed across the entire surfaces of the polymer-ceramic panels 40. The inserts 44 are arranged in columns along the width of each panel 40, with inserts 44 of one column being offset relative to inserts 44 of the adjacent column by the radius of one insert 44 to thereby cover the panels 40 with inserts 44 to the best possible extent.

The wear resistant inserts 44 can be attached to the elastic material layer 42 also by vulcanizing, e.g. by vulcanizing ceramic inserts 44 into a layer of polymer based material 42. Alternatively or in addition, the wear resistant inserts 44 can be retained within the elastic material layer 42 mechanically by means of a press fit and/or a form fit.

In order to fasten the shell liner 30 of the invention to the shell 18 of a mill 1, several different possibilities exist.

On the one hand, the shell liner 30 can be releasably fastened within the shell 18 by fastening the polymer-ceramic panels 40 as such within the shell 18. The elastic material layer 42 of a panel 40 can be releasably fastened to the shell 18 by any releasable fastening means known in the art, e.g. by means of a screw or bolt connection, by clamping or the like.

On the other hand, as show in the above embodiments, the shell liner 30 may further comprise a reinforcement plate 50, and if so, the shell liner 30 is suitably releasably fitted within the shell 18 by fastening the reinforcement plate 50 within the shell 18. The reinforcement plate 50 can in turn be fastened to the shell 18 by any releasable fastening means known in the art, e.g. by means of a screw or bolt connection, by clamping or the like, or simply by being seated onto a supporting structure, i.e. in a form-fitting manner.

According to the invention, at least a part of an exposed surface of the shell liner 30 constitutes a wear surface. An exposed surface is a surface of the shell liner 30 which is exposed within the grinding chamber 15 and therefore exposed to contact with material passing the mill. Exposed surfaces of the wear resistant inserts 44 form part of the wear surface of the shell liner 30. Areas of the shell liner 30 outside of this wear surface can, however, be devoid of any wear-resistant inserts 44.

Uneven wear of the liners has been observed in stirred grinding mills, with the wear occurring faster at liners in the lower compartments (at the feed end) than in the upper compartments (at the discharge end). One cause of the uneven wear may be that the grinding media beads are only partially fluidized, meaning that only a portion of their weight is carried by the upward flow of feed slurry. The remainder of the gravitational force is born downwards through the packed bed of grinding media beads such that the gravitational force is highest at the bottom of the grinding mill. This increases the force on the mill shell which is therefore subject to a higher wear rate towards the bottom of the grinding mill.

Another cause of the uneven wear may be that the coarse feed particles are introduced into the bottom of the grinding mill, which is likely to also increase the wear rate at the base of the grinding mill.

In case of uneven wear of the shell liners 30, individual worn shell liners 30 can be replaced and others can be left unchanged, which reduces the maintenance work and cost as well as spare part costs.

Although not explicitly shown, shell liners 30 of this invention may have a further novel configuration to compensate for uneven wear. In fact, uneven wear may occur also across individual liners or even across individual polymer-ceramic panels of liners according to this invention, as areas of the liners 30 and panels 40 that are directly facing the rotor disks 12 during operation of the mill 1 are subject to significantly stronger abrasion wear and therefore wear away quicker than other areas of the panels 40 or liners 30, respectively. To compensate for this phenomenon, shell liners 30 of this invention may have bulges or thickened areas where the thickness of the polymer layer 42, and/or the dimension of the wear resistant inserts 44 in the thickness direction of the panel 40, is larger than in other areas of the panel 40.

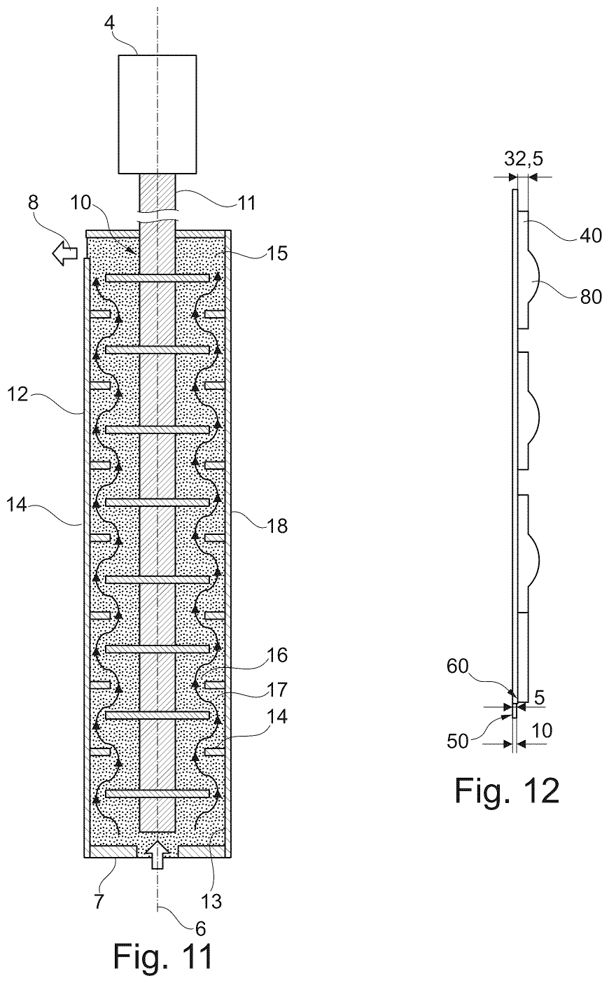

FIG. 11 corresponds to FIG. 4 and schematically indicates areas 70 within the shell 18 where corresponding bulges or thickened areas of shell liners 30 would suitably be arranged.

FIG. 12 corresponds to FIG. 9b and schematically indicates convex bulges 80 formed on panels 40 of the shell liner 30. The bulges 80 may extend from the panels 40 only to a small extent, e.g. corresponding to about 10% of the thickness of the panels 40, but also to a larger extent such as corresponding to about 50% up to 100% or more of the thickness of the panels 40.

Although the invention has been described with reference to specific examples, it will be appreciated by those skilled in the art that the invention may be embodied in many other forms.

For example, while the shell liners 30 illustrated herein have the shape of hollow half cylinders, shell liners 30 of this invention could have the shape of other cylindrical segments such as the shape of a hollow ⅓-cylinder (a 120 degrees segment of a cylinder) or the shape of a hollow ¼-cylinder (a 90 degrees segment of a cylinder). A shell liner could also have the shape of a hollow full-cylinder; in this case, a radius of the central opening 16 of the grinding element 80 must be larger than an outer radius of a rotor disk 12 in order to allow for the drive shaft 11 and rotor disks 12 to pass through the opening 16 during installation.

What is claimed is:

1. A shell liner for a stirred grinding mill, wherein the shell liner is configured to be releasably fitted to the inside of a shell of the mill within a grinding chamber thereof, and wherein at least a part of a surface of the shell liner that is configured to be exposed within the grinding chamber constitutes a wear surface, wherein the shell liner comprises:
at least one polymer-ceramics panel comprising an elastic material layer and wear resistant inserts retained by the elastic material layer, wherein exposed surfaces of the wear resistant inserts form part of the wear surface of the shell liner.

2. The shell liner of claim 1, wherein the shell liner is curved into the shape of a segment of a hollow cylinder.

3. The shell liner of claim 1, further comprising a reinforcement plate supporting the at least one polymer-ceramics panel.

4. The shell liner of claim 1, further comprising a plurality of polymer-ceramics panels disposed in at least one row and/or at least one column.

5. The shell liner of claim 1, further comprising at least two polymer-ceramics panels spaced apart from one another in a height direction of the panel.

6. The shell liner of claim 1, further comprising at least one mounting hole for fixing stator elements, such a stator rings, or segments thereof.

7. The shell liner of claim 6, further comprising at least two polymer-ceramics panels spaced apart from one another in a height direction of the panel, wherein the at least one mounting hole is disposed in the spacing between the two panels.

8. The shell liner of claim 1, wherein a thickness of a first polymer-ceramics panel of the shell liner is larger than a thickness of a second polymer-ceramics panel of the shell liner, the variation in thickness resulting from the panels having elastic material layers with different thicknesses and/or wear-resistant inserts with different dimensions in a thickness direction of the panels.

9. The shell liner of claim 1, wherein the at least one of the polymer-ceramics panel of the liner has a bulge or other thickened area where the thickness of the elastic material layer and/or the dimension of the wear resistant inserts in the thickness direction of the panel is larger than in other areas of the panel.

10. The shell liner of claim 9, wherein the bulge or other thickened area is positioned where the at least one polymer-ceramics panel is configured to face a rotor disk configured to rotate in the grinding chamber of the mill.

11. The shell liner of claim 9, wherein the bulge or other thickened area extends along a width of the liner and thereby along an inner circumference of the shell in the shell-mounted state of the liner.

12. A stirred grinding mill comprising:
a shell;
a grinding chamber;
a stirring assembly arranged in the grinding chamber for rotating therein; and
at least one shell liner including at least one polymer-ceramics panel including an elastic material layer and wear resistant inserts retained by the elastic material layer, wherein exposed surfaces of the wear resistant inserts form part of the wear surface of the shell liner,
wherein the at least one shell liner is releasably fitted to the inside of the shell within the grinding chamber thereof.

13. The stirred grinding mill of claim 12, wherein the shell liner is releasably fitted to an inside of the shell of the mill by fastening the elastic material layer of the at least one polymer-ceramics panel of the liner to the inside of the shell.

14. The stirred grinding mill of claim 12, wherein the shell liner further comprises the reinforcement plate, and the shell liner is releasably fitted to an inside of the shell of the mill by fastening the reinforcement plate of the liner to the inside of the shell.

15. The stirred grinding mill of claim 12, comprising several shell liners, wherein a thickness of at least one polymer-ceramics panel of a shell liner disposed further towards the bottom or inlet end of the shell is larger than a thickness of at least one polymer-ceramics panel of a shell liner disposed further towards the top or outlet end of the shell, the variation in thickness resulting from the panels having elastic material layers with different thicknesses and/or wear-resistant inserts with different dimensions in a thickness direction of the panels.

16. The stirred grinding mill of claim 12, wherein the a stirring assembly comprises:
a drive shaft with a number of rotor disks disposed along the length of the drive shaft, or
an agitator screw arranged concentrically with and inside the grinding chamber for rotating therein.

17. The stirred grinding mill of claim 12, wherein the grinding chamber is arranged essentially vertically, or essentially horizontally.
